(19) United States
(12) Patent Application Publication
(10) Pub. No.: US 2021/0158348 A1
(43) Pub. Date: May 27, 2021

(54) TRACKING DEVICE IDENTIFICATION DATA AND ACCOUNT ACTIVITIES FOR ACCOUNT CLASSIFICATION

(71) Applicant: PAYPAL, INC., San Jose, CA (US)

(72) Inventors: Bradley Wardman, Scottsdale, AZ (US); Jakub Burgis, Augusta, MD (US)

(21) Appl. No.: 16/691,536

(22) Filed: Nov. 21, 2019

(51) Int. Cl. G06Q 20/40; G06Q 20/32; G06Q 20/10; G06Q 40/02; H04W 4/24; H04M 15/00

(52) U.S. Cl. CPC G06Q 20/40; G06Q 20/32; H04M 15/00; G06Q 40/02; H04W 4/24; G06Q 20/10

(57) ABSTRACT

Device identification data, network connection data, and other related data may be analyzed to determine an account classification, particularly before the account has even been used (or before extensive use has occurred). An account with direct or indirect access to databases may be created by a user, where a service provider may wish to assess the account's creation to detect if a bad actor is generating the account to engage in malicious computing actions or fraud. The account's creation data may be scored by an intelligent engine that detects malicious or fraudulent account creations, for example, based on whether a virtual private network is used to create the account, whether a VoIP phone number is being used, etc. The account may be monitored over a period of time and the account activities analyzed again to determine whether technical data associated with the account indicates a particular risk classification is appropriate.

### TECHNICAL FIELD

The present application generally relates to using analytic data regarding device hardware, software, network connections, and other related information that may be used during account creation to classify accounts prior to account usage, according to various embodiments.

### BACKGROUND

User accounts routinely provide access to databases, compute services, transaction execution, and other capabilities. Platforms that allow access to large numbers of users (e.g. the general public) may be at risk of computer security breaches and other service terms violations (e.g. account fraud), however, when a user account is established by a malicious actor who may desire to breach system security protocols and rules of use. Once a user account has been observed attempting to violate security protocols or other rules of use, it may be possible to identify that the user account is being used for malicious purposes. More difficult, however, is identifying whether a newly established user account (or an account without much history) is likely to engage in behavior that will circumvent security protocols or other platform usage rules.

### BRIEF DESCRIPTION OF THE DRAWINGS

FIG. 1 is a block diagram of a networked system suitable for implementing the processes described herein, according to an embodiment;

FIG. 2 are exemplary escalation tiers and corresponding data that may be processed to determine if the account is potentially fraudulent, according to an embodiment;

FIG. 3 is an exemplary system environment where a user device and an account service provider server may interact to detect accounts created with the intent to commit fraudulent acts, according to an embodiment;

FIG. 4 is a flowchart for tracking of device identification data and account activities for identification of fraudulent accounts, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for tracking of device identification data and account activities for the identification of fraudulent accounts according to various embodiments. Systems suitable for practicing methods of the present disclosure are also provided.

As the volume of sensitive information stored and transacted with over the internet continues to increase, the need to identify maliciously created accounts that may engage in fraudulent behavior becomes critical. Fraudulently created accounts may be utilized by bad actors to engage in unwanted actions, such as laundering money, engaging in fraudulent transactions, interfering in politics and other discourses, act as a proxy service for bad actions, and/or “troll” users and entities by posting false or abusive content. Often, several fraudulent accounts may be created at once. Furthermore, once a bad actor has generated an account, accounts are generally aged to appear valid, which does little to prevent future attacks and allows the accounts to appear legitimate. While organizations have taken measures to improve security and validate account creation (e.g., requiring more particular user data, monitoring account actions, etc.), not all measures can prevent bad actors from generating and aging accounts that are fraudulent, which allows the accounts to appear valid and be used to engage in bad behaviors.

Various types of service providers may provide accounts and account services to users (e.g. members of the public). For example, a social networking, email, messaging, payment transaction provider, or other service provider may provide a platform where a user may create an account and engage in various actions (e.g., social networking posting or interacting, emailing, messaging, etc.). A transaction processor (e.g., PayPal®) may provide electronic transaction processing for online transactions through an account, where a user may process the transactions through a digital wallet of the account that stores value and/or financial instruments for the user. Thus, the user may create an account with the transaction processor or other entity, which may then be used to engage in actions. The service provider may provide an online platform that allows the user to engage in these actions, such as processing transactions, transferring money, interacting with other users, posting content, or engaging in some other service provider through the platform, application, and/or website. However, bad actors and other malicious entities may create these accounts to engage in fraud, attempt to breach platform security, or perform other malicious activities, and therefore abuse the services provided by the service provider. For example, bad actors may engage in fraudulent transactions (e.g., money laundering or other fraudulent transaction), interfere in elections, troll users, or otherwise behave in an abusive or fraudulent manner.

In order to establish an account, the user may access an account establishment process with the transaction provider. The user may provide identification information to establish the account, such as personal information for a user, business or merchant information for such an entity, or other types of identification information including a name, address, and/or other information. The user may also be required to provide financial information, including payment card (e.g., credit/debit card) information, bank account information, gift card information, and/or benefits/incentives, which may be used to provide funds to the account and/or an instrument for transaction processing. In order to create an account, the user may be required to select an account name and/or provide authentication credentials, such as a password, personal identification number (PIN), answers to security questions, and/or other authentication information. Additional technical information will often accompany the account creation process—what type of hardware device (e.g. smartphone, laptop, etc.) is being used to access the account creation process, what is the network address and/or type of network being used, what software (and versions) are on the user device, etc.

The user's account may then be used by the user to perform electronic transaction processing, access a database, or engage in another electronic service with the service provider. A computing device may execute a resident dedicated application of the service provider, which may be configured to utilize the services provided by the service provider, including interacting with one or more other users and/or entities. In various embodiments, a website may provide the services, and thus may be accessed by a web browser application. The application (or website) may be associated with a payment provider, such as PayPal® or other online payment provider service, which may provide payments and the other aforementioned transaction processing services, which may be abused through accounts created by bad actors for the purposes of fraud, malicious attacks, or other bad behavior. However, other service providers may provide other types of services, which may similarly be abused (e.g., social network posting, email/messaging spam or phishing attempts, etc.). Thus, the service provider may wish to identify those fraudulently created accounts, accounts created with the intent of engage in bad behavior or service abuse, or accounts engaging in this bad behavior or service abuse.

In order to detect these accounts created and/or used by bad actors, an escalation tier system may be implemented by the service provider to escalate account risk and/or fraud detection based on one or more factors of the account's creation and/or usage. Initial account monitoring and assessment may occur first at account creation, such as in real-time or substantially real-time at creation of the account (e.g., during the account creation request and submission of account data, such as name, personal and/or financial information, etc.). Additionally, account assessment for previously created accounts may also be performed after account creation, for example, by retroactively assessing accounts based on account data (including account creation data, account use data, and other data linked to an account). If the data indicates that the account may have been generated with the intent to commit fraud or is attempting/engaging in fraud, escalation between tiers may occur. Thus, if an initial assessment of the account indicates some risk or fraud, such as a risk assessment, level, or score exceeding a threshold, additional account monitoring and assessment may occur with regard to activities engaged in by the account. Based on the continued account monitoring and escalation between tiers, restrictions may be placed on the account, identification verification of the user for the account may be required, and/or the account may be deleted or banned. Escalation may occur between two or more levels or tiers, as well as skipping one or more tiers based on the risk level or score of the potentially fraudulent account's data.

For example, the tiers may correspond to tiers 3, 2, 1, and 0, where proceeding from 3 to 0 indicates a higher risk of potential fraud, account abuse, or malicious use of services using the account. At a tier 3, the account is initially assessed with regard to account creation data, such as at a time of the account creation or at some later time using the account creation data. The account creation data may correspond to that data that is detected, generated, and/or determined at a time of creation of the account, such as when a user requests for the account to be created with the service provider. This may include input from the user for the account, such as user personal information, financial information, a contact physical address provided by the user for billing, shipping, or a profile, and/or a naming convention of the account name (e.g., an entered user name requested for the account). The data may also correspond to an email address provided by the user, which may be used to determine if the email address corresponds to a service provider that requires no or minimal information to establish, and therefore is more prone to being used by fraudsters or other bad actors that may wish to hide their identity. In contrast, an email address for a service provider that requires certain information that may be used to determine and/or validate a user's identity may be more secure and less risky as fraudsters would not wish for their identities to be determined. Similarly, a phone number may be provided, where the phone number may be analyzed to determine if the number corresponds to a voice over IP or LTE (VoIP or VoLTE) number that may be easily requested and accessed by a fraudster, or if the number corresponds to a publicly switched telephone network (PSTN), cellular network, or other telephone network that requires user information that may be confirmed and/or used to identify an individual.

An IP address or other network address of a device of the user that is detected at account creation may be used to match to the provided physical address, as well as determine whether the account creation occurred using a virtual private network (VPN) or using a virtual machine. In such embodiments, if a VPN or virtual machine is used, it may be more likely that a fraudster or other bad actor has generated the account to use maliciously as the bad actor would be attempting to hide their identity and/or prevent identification of the bad actor or information about the bad actor (e.g., location, device identifier, etc.). Other device data for the device requesting the account creation may also be used, such as application data of one or more applications on the device, browser data including search histories and/or visited websites, proxy network usage, and the like. For example, how the user accessed the service provider, including a user agent string, may be assessed for indications of a fraudulent actor. The data may be assessed to generate a score, rating, level, or other quantitative assessment of the account data by an intelligence engine of the service provider, and may be compared to a threshold that is required to be met and/or exceeded in order to escalate the account to the next level. For example, a threshold risk score of the account being fraudulent may be a 50 or in the 50^{th} percentile, whereby scoring the account data based on one or more factors, weights, and other information may generate a score that is compared to the threshold. In some embodiments, if the account is assessed after creation, additional account data, such as account activities and other monitoring data generated from monitoring the account, may also be processed to determine whether the account is fraudulently created with the intent to commit bad acts, such as the data used at tiers 2, 1, and/or 0 as discussed herein.

If the account data at tier 3 causes escalation to tier 2, at tier 2 the account may be monitored to track further account data, including account actions, activities, and further account input by a user. This may include transaction data for one or more transactions conducted by the user using the account, such as an amount of the transaction(s), number of transactions performed (which may be over a time period, such as a number per day or month), recipient of funds from the transaction(s), items in the transaction(s), person-to-person (P2P) transactions and usage, or other information about the transaction(s). In some embodiments, escalation from tier 3 to tier 2 may cause one or more account restrictions to take place, or be placed on the account, which may be monitored for compliance. For example, detection of a possibly fraudulently created account at tier 3 may limit the account to a maximum transaction amount (e.g., $100) or to a certain number of transactions (e.g., 3 per day). If these limits are met or exceeded when the account's data is escalated to tier 2 and monitored, the fraudulent account detection system may further utilize this data to determine whether to further escalate the account to tier 1 or tier 0, thereby requiring additional user data, identity confirmation, fraud prevention information, and/or establishing limitations on the account or banning the account.

Additional data that may be examined and/or assessed at tier 2 may include an age and/or length of time since establishment of the email address or phone number, a usage and/or age of a physical address provided for the account, and/or other online presence of the user and/or user's data. For example, the user may have other accounts with other online platforms, such as a social networking account, microblogging account, career services account, or other data that may be matched to the data provided for the account and/or used to determine additional information about the user. The online presence may further include other activities engaged in by the user and/or user's device online, which may indicate fraud or other malicious activities by the user. The other account data processed by the user may also include account actions and entities interacted with by the user, such as recipients of messages, funds received by the account from other accounts, and/or other actions. Funds in the account may be monitored for usage, such as transactions and transfers, as well as movement between sub-accounts and/or length in the account. In a similar manner to tier 3, the account data that is monitored at tier 2 may be scored and compared to a threshold by an engine performing the fraudulent account detection by the service provider. Additionally, one or more further limitations may be imposed on the account, such as further restricting account activities and/or actions, preventing the account from performing one or more activities, preventing login and/or use of the account, and/or alerting one or more other users or accounts of the risk assessment.

If the score requires escalation to tier 1 and/or tier 0, additional data may be requested from the user in order to verify the user's identity. The information may correspond to “Know Your Customer” (KYC) information, “Customer Identification Program” (CIP) required information, or “Personally Identifiable Information” (PII). A request for all or a portion of the information may be transmitted to the user and/or user's device, or may be accessed through the account (e.g., appearing as a notification, interface element, pop-up, push notification or banner, etc.). The user may then provide a response to the information, which may be confirmed. If the information may be confirmed, the escalation of the account's risk status or assessment may be lowered (e.g., to tier 2 or 3 depending on a further risk assessment) and/or removed, thereby lowering or removing restrictions or limitations placed on the account. The information may be provided through an identity card (e.g., driver's license or passport), providing address confirmation (e.g., a bill), a bank statement, or may be entered by the user to one or more interfaces. However, if the information cannot be confirmed or further appears fraudulent (e.g., by exceeding another threshold for escalation from tier 1 to tier 0), escalation may occur to tier 0 where the user may be required to provide in-person identity verification, including providing a driver's license, passport, or other identity confirmation to a trusted person. These are merely exemplary processes by which an account may be escalated, but the account may also be escalated based on other factors concerning the account. Thus, additional paths of account escalation may occur, such as using different information or immediately escalating an account between tiers (e.g., from tier 3 to tier 1 or 0 based on the information regarding the account). This may be done by having the user visit a location of the trusted person or by sending the trusted person to a location of the user. Absent identity confirmation, the account may be partially or entirely restricted, and may be banned or deleted if not provided within a time frame.

As previously discussed, restrictions may be placed on the account at different tiers, which may restrict account usage and/or account access. For example, the restrictions may limit electronic transaction processing, such as a transaction amount, number, recipient, items, or other transaction information. The restrictions may also be associated with other account actions, such as messaging, social network posting, and microblogging, which may then be limited. The limitations on other account activities may limit the activities or may filter content associated with the activities (e.g., limiting posting of other sources, use of particular words, etc.). The restrictions may be location based, such as limiting interactions to a particular geographical area or barring interactions with users/accounts/devices in other geographical areas, or based on other information. Without providing the required data to de-escalate the account risk to a prior account risk and escalation tier (or removing the account risk assessment entirely), the restrictions may remain in place and the account may continue to be monitored. Moreover, escalation between tiers may be gradual and tiers may include mid-tiers, such as a 1.5 tier where the restrictions may not be as serious or restrictive as tier 1 and/or the user confirmation data may include less than that required at tier 1. Mid-tiers may be implemented when other data, such as a length of account usage and/or usage of the account, may indicate that the account is valid.

Based on the account assessments, the fraudulent account assessment system may update the intelligent scoring system, the system's weights, thresholds, or other assessment data based on fraudulently detected accounts and accounts determined to be valid. In this manner, a service provider may utilize an intelligent scoring system to determine account validity and identify accounts created with the intent to commit fraud or are actually engaging in fraudulent behavior (or other bad actions). This allows users of an online platform to be more confident that the accounts the users are interacting with are not providing false or fraudulent data or performing other bad acts, such as computing attacks, fraudulent electronic transaction processing, or other malicious acts. For example, the system assists by preventing proliferation of false data across multiple platforms that may be susceptible to data breach or mishandling. The service may therefore provide increased account security and verification, reduce fraud, and otherwise prevent abuse of an online service provider's platform and services.

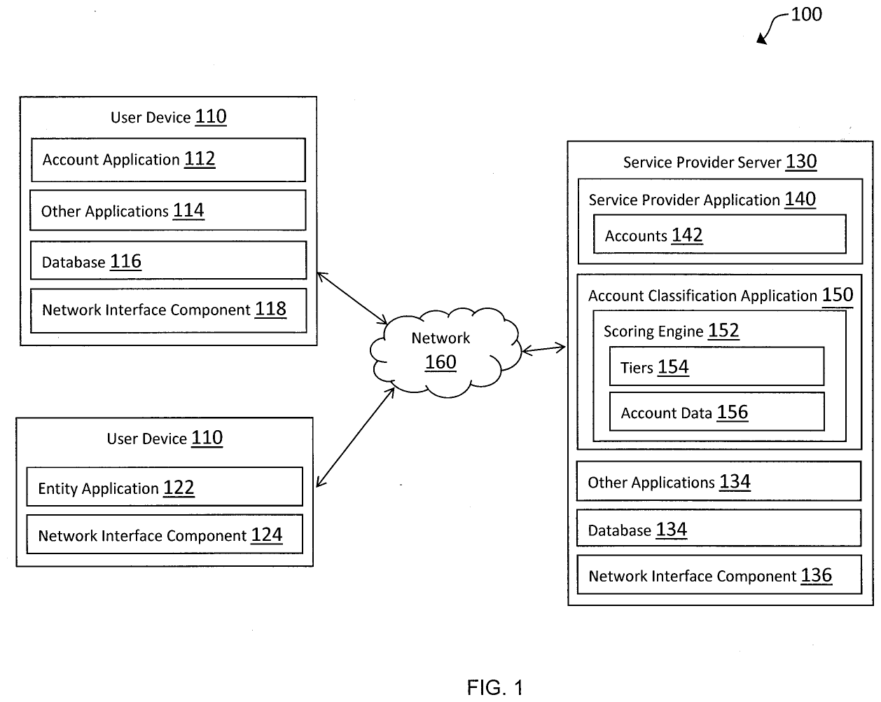

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user device 110, an interacting entity 120, and a service provider server 130 in communication over a network 160. User device 110 may be utilized to access the various features available for user device 110, which may include processes and/or applications associated with account usage of an account provided by service provider server 130, including interacting with interacting entity 120 using the account. User device 110 may be used to establish and maintain the account with service provider server 130. In this regard, service provider server 130 may determine whether the account was generated with the intent to commit fraud or other bad acts, or may be engaging in such bad acts.

User device 110, interacting entity 120, and service provider server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

User device 110 may be implemented as a communication device that may utilize appropriate hardware and software configured for wired and/or wireless communication with interacting entity 120, and/or service provider server 130. For example, in one embodiment, user device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS 0), other type of wearable computing device, implantable communication devices, and/or other types of computing devices capable of transmitting and/or receiving data. User device 110 may correspond to a device of a valid user or a fraudulent party utilizing an account to interact with one or more other entities, including interacting entity 120. Although only one user device is shown, a plurality of user devices may function similarly.

User device 110 of FIG. 1 contains an account application 112, other applications 114, a database 116, and a network interface component 118. Account application 112 and other applications 114 may correspond to executable processes, procedures, and/or applications with associated hardware. In other embodiments, user device 110 may include additional or different modules having specialized hardware and/or software as required.

Account application 112 may correspond to one or more processes to execute software modules and associated devices of user device 110 to establish an account and utilize the account, for example, to process electronic transactions or deliver content over a network with one or more other services and/or users. In this regard, account application 112 may correspond to specialized hardware and/or software utilized by a user of user device 110 that may be used to access a website or an application interface of service provider server 130 that allows user device 110 to establish the account, for example, by generating a digital wallet having financial information used to process transactions with interacting entity 120. Thus, account application 112 may be used to request establishment of the account from service provider server 130. As discussed herein, account application 112 may provide user information and user financial information, such as a credit card, bank account, or other financial account, for account establishment. Additionally, account application 112 may establish authentication credentials and/or by a data token that allows account access and/or use. Other data may also be provided with the account establishment, such as device data, application data, network data, or other information that is detected during account establishment. Additionally, during account use, account application 112 may be used to request use of services, utilize such services, and/or provide additional data, such as by requesting processing of a transaction and/or providing additional data that may verify an identity of a user.

In various embodiments, account application 112 may correspond to a general browser application configured to retrieve, present, and communicate information over the Internet (e.g., utilize resources on the World Wide Web) or a private network. For example, account application 112 may correspond to a web browser, which may send and receive information over network 160, including retrieving website information (e.g., a website for service provider server 130), presenting the website information to the user, and/or communicating information to the website, including account data. However, in other embodiments, account application 112 may include a dedicated application of service provider server 130 or other entity (e.g., a merchant), which may be used to access and use an account and/or account services. Account application 112 may utilize one or more user interfaces, such as graphical user interfaces presented using an output display device of user device 110, to enable the user associated with user device 110 to establish the account, utilize the account or other service, and/or provide information requested by service provider server 130 to validate an account and/or verify an identity of a user of the account. In certain aspects, account application 112 and/or one of other applications 114 may provide data that may be used by service provider server 130 to make a risk assessment of account fraud detection. Additionally, account application 112 may be used to respond to a request for information, such as KYC information, CIP requirement information, and/or PII.

In various embodiments, user device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160. In various embodiments, other applications 114 may include an application used with interacting entity 120 to provide device, application, and/or account data. Other applications 114 may include device interface applications and other display modules that may receive input from the user and/or output information to the user. For example, other applications 114 may contain software programs, executable by a processor, including a graphical user interface (GUI) configured to provide an interface to the user. Other applications 114 may therefore use components of user device 110, such as display components capable of displaying information to users and other output devices, including speakers.

User device 110 may further include database 116 stored in a transitory and/or non-transitory memory of user device 110, which may store various applications and data and be utilized during execution of various modules of user device 110. Database 116 may include, for example, identifiers such as operating system registry entries, cookies associated with account application 112 and/or other applications 114, identifiers associated with hardware of user device 110, or other appropriate identifiers, such as identifiers used for account authentication or identification. Database 116 may include account data stored locally, as well as data provided to service provider server 130 during account establishment and/or use.

User device 110 includes at least one network interface component 118 adapted to communicate with interacting entity 120 and/or service provider server 130. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Network interface component 118 may communicate directly with nearby devices using short range communications, such as Bluetooth Low Energy, LTE Direct, WiFi, radio frequency, infrared, Bluetooth, and near field communications.

Interacting entity 120 may be maintained, for example, by an online service provider, user, or other entity, such as a merchant that may sell goods to users or other users that may utilizes services provided by service provider server 130. Interacting entity 120 may be used to provide item sales data over a network to user device 110 for the sale of items, for example, through an online merchant marketplace. However, in other embodiments, service provider server 130 may be maintained by or include another type of user or service provider that may interact with user device 110 via an account established and maintained by user device 110. In this regard, interacting entity 120 includes one or more processing applications which may be configured to interact with user device 110.

Interacting entity 120 of FIG. 1 contains an entity application 122 and a network interface component 124. Entity application 122 may correspond to executable processes, procedures, and/or applications with associated hardware. In other embodiments, interacting entity 120 may include additional or different modules having specialized hardware and/or software as required.

Entity application 122 may correspond to one or more processes to execute modules and associated specialized hardware of interacting entity 120 to interact with user device 110, for example, by allowing for the purchase of goods and/or services from the service provider or merchant corresponding to interacting entity 120. In this regard, entity application 122 may correspond to specialized hardware and/or software of interacting entity 120 to provide a convenient interface to permit a user or other entity associated with interacting entity 120 to interact with user device 110. For example, entity application 122 may be implemented as an application having a user interface enabling a merchant to enter item information and request payment for a transaction on checkout/payment of one or more items/services. In other embodiments, entity application 122 may allow other or different interactions with user device 110, for example, messaging, email, viewing or accessing online content (e.g., social networking posts), and the like. In certain embodiments, entity application 122 may correspond more generally to a web browser configured to view information available over the Internet or access a website. Entity application 122 may provide data used for determination of a risk assessment and/or escalation between risk tiers of an account. Additionally, an account used to interact with entity application 122 may be limited or restricted based on account data that escalates the account risk assessment, restrictions, and/or required user identity data to a specific risk tier.

Interacting entity 120 includes at least one network interface component 124 adapted to communicate with user device 110 and/or service provider server 130 over network 160. In various embodiments, network interface component 124 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Service provider server 130 may be maintained, for example, by an online service provider, which may provide transaction processing services on behalf of users including fraud/risk analysis services for account creation and use. In this regard, service provider server 130 includes one or more processing applications which may be configured to interact with user device 110, interacting entity 120, and/or another device/server to facilitate transaction processing. In one example, service provider server 130 may be provided by PAYPAL®, Inc. of San Jose, Calif., USA. However, in other embodiments, service provider server 130 may be maintained by or include another type of service provider, which may provide fraud assessment services of account creation and/or use.

Service provider server 130 of FIG. 1 includes a service provider application 140, an account classification application 150, other applications 132, a database 134, and a network interface component 136. Service provider application 140, account classification application 150, and other applications 132 may correspond to executable processes, procedures, and/or applications with associated hardware. In other embodiments, service provider server 130 may include additional or different modules having specialized hardware and/or software as required.

Service provider application 140 may correspond to one or more processes to execute software modules and associated specialized hardware of service provider server 130 to provide services to users, for example though an account that may be established using service provider server 130. In this regard, service provider application 140 may correspond to specialized hardware and/or software to provide services through accounts 142, including transaction processing services using digital wallets storing payment instruments. The services may allow for a payment through a payment instrument using one of accounts 142, or may correspond to other services, including messaging, email, social networking, microblogging, media sharing and viewing, or other types of online interactions and services. In order to establish an account of accounts 142 to utilize services and interact with other entities, service provider application 140 may receive information requesting establishment of the account. The information may include user personal, business, and/or financial information. Additionally, the information may include a login, account name, password, PIN, or other account creation information. The entity establishing the account may provide a name, address, social security number, or other personal or business information necessary to establish the account and/or effectuate payments through the account.

Service provider application 140 may further allow the entity to service and maintain the account of accounts 142, for example, by adding and removing information and verifying an identity of the entity controlling the account through entity information and identity validation, such as KYC information, CIP requirement information and processes, and/or PII. Where the services correspond to transaction processing services, service provider application 140 may debit funds from an account of the user and provide the payment to an account of the merchant or service provider when processing a transaction, as well as provide transaction histories for processed transactions. However, where the services of service provider application 140 correspond to other services, service provider application 140 may be used to perform other services, such as messaging other users and entities, posting data on an online platform, or otherwise utilizing the service.

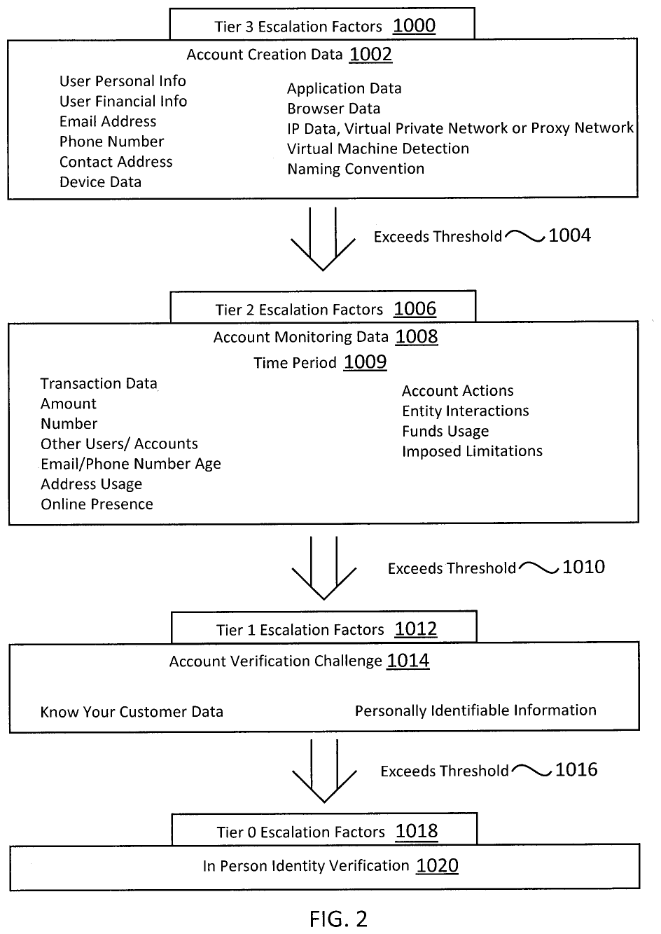

Account classification application 150 may correspond to one or more processes to execute software modules and associated specialized hardware of service provider server 130 to detect those of accounts 142 that may be generated with the intent to commit fraud or bad acts and/or those of accounts that may be currently engaging in such bad acts. In this regard, account classification application 150 may correspond to specialized hardware and/or software to provide account classification as may relate to fraud detection and risk assessment of accounts at startup, during use, and after assessing an account as possibly fraudulent or engaging in fraudulent activity. In this regard, account classification application 150 may first assess accounts at a base level, such as a tier 3 or other initial tier of a tiered escalation system. This may occur at account setup using account creation or setup information, including personal information, financial information, device data, network data, or other processing data detected during the account creation, such as through the input by the user, device used for the setup, and/or network used for the setup. In some embodiments, this may occur after account creation to detect latent fraudulently created accounts, which may have been missed or omitted from an initial review. This data, factors used for account fraud detection, and/or weights may be processed by scoring engine 152 for account classification provided by account classification application 150. In this regard, scoring engine 152 includes tiers 154, where accounts may be escalated between risk different tiers of tiers 154 based on account data 156 for accounts 142. These factors and weights for account escalation between tiers 154 are discussed in further detail with regard to FIGS. 2-4.

After an initial assessment of one of accounts 142 that indicates the account was created with the intent of committing fraud or other bad acts, scoring engine 152 of account classification application 150 may escalate the accounts risk assessment to another tier, such as a tier 2, where the account may be monitored and further data of account data 156 is generated based on the actions and activities of accounts 142. Additionally, restrictions or limitations may be set of the account, such as by limiting actions or activities that the account may engage in through service provider server 130 or another platform. If the account monitoring data generated based on this assessment further indicates that the account was generated with the intent to commit fraud or other bad actions, or is actively engaging in those acts, a further escalation between tiers 154 may be performed. This may include placing more restrictive limitations on the account or placing a hold on the account's activities. At this point, additional information, such as KYC information, CIP requirement information, or PII may be required to be submitted by the user for the account. This may include verifying an identity of the user through a digitally submitted document, such as a driver's license or passport, or may require in-person identification. These factors and weights for account escalation between further tiers of tiers 154 (e.g., tiers 2-0) are discussed in further detail with regard to FIGS. 2-4. Moreover, if the user is capable of verifying an identity and/or overcoming any request for user identity data, account classification application 150 may remove the limitations or lessen those limitations. However, if the data is insufficient or not provided by the user, the account may be further restricted, deleted, or banned from using the platform.

In various embodiments, service provider server 130 includes other applications 132 as may be desired in particular embodiments to provide features to service provider server 130. For example, other applications 132 may include security applications for implementing server-side security features, programmatic client applications for interfacing with appropriate application programming interfaces (APIs) over network 160, or other types of applications. Other applications 132 may contain software programs, executable by a processor, including a graphical user interface (GUI), configured to provide an interface to the user when accessing service provider server 130, where the user or other users may interact with the GUI to more easily view and communicate information. In various embodiments, other applications 132 may include connection and/or communication applications, which may be utilized to communicate information to over network 160.

Additionally, service provider server 130 includes database 134. As previously discussed, a user may establish one or more accounts with service provider server 130. Accounts in database 134 may include user information, such as name, address, birthdate, payment instruments/funding sources, additional user financial information, user preferences, authentication information. and/or other desired user data. Users may link to their respective accounts through an account, user, and/or device identifier. Thus, when an identifier is transmitted to service provider server 130, e.g., from user device 110, one or more accounts belonging to the users may be found and accessed. Database 134 may also include accounts 142 and account data 156, which may be used when making a risk assessment of the account to determine whether the account is fraudulent.

In various embodiments, service provider server 130 includes at least one network interface component 136 adapted to communicate with user device 110 and/or interacting entity 120 over network 160. In various embodiments, network interface component 136 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

FIG. 2 are exemplary escalation tiers and corresponding data that may be processed to determine if the account is potentially fraudulent, according to an embodiment. Environment 200 of FIG. 2 shows tiers of an intelligent scoring engine that may be used to detect when an account has been generated with the intent of committing fraud and/or is engaging in fraudulent behavior or other bad acts. In this regard, environment 200 includes tier 3 escalation factors 1000, tier 2 escalation factors 1006, tier 1 escalation factors 1012, and tier 0 escalation factors 1018, where the engine may escalate a risk assessment of an account from tiers between a tier 3 to a tier 0 based on particular account data and factors detected at account creation and/or usage.

Tier 3 escalation factors 1000 may include those factors for the engine that are associated with account creation data 1002, which may be detected and/or generated when an account is requested to be created. For example, an account may be created by either a bad actor with the intent to commit fraud or may be created by a legitimate user. During the account creation, account creation data 1002 is generated or provided by the particular user, which may include input of user personal information, user financial information, an email address, a phone number, a contact address (e.g., a physical location), or other input. Additionally, the service provider's risk analysis of an account may detect device data (e.g., device parameters, components, identifiers, and the like), application data for one or more applications on the device including the application used to request the account creation, browser data for a browser accessing the service provider, IP data or an IP address of the device, a virtual private network or proxy network detected being used by the device, detection of a virtual machine being used for the account creation, and/or a naming convention of the account. In this regard, this account creation data 1002 may be processed to detect indications that a fraudulent actor is attempting to create the account. For example, fraudulent actors may attempt to hide or obscure their identity, and therefore may utilize false data, VPNs, or proxy networks to hide the user's name, device identifier, device location, and the like.

The bad actor (or potentially legitimate user) may also be required to provide an email address, telephone number, or other contact identifier to establish the account, which the bad actor may wish to create with minimal user data so that the contact identifier cannot be traced to the bad actor and/or identify the bad actor, or is easy to establish and does not cost the bad actor. For example, a VoIP phone number may be easily obtained without requiring user identification and verification, or an email address of certain service providers may be quickly created without having to provide any identifying details. Such contact addresses that are provided by these service providers are more likely to be used by fraudsters and therefore these may increase a risk score or assessment of the account as more likely to be fraudulent. Moreover, naming conventions of the account and/or contact address may indicate fraud when comparing to other fraudulent accounts or the naming convention indicates a plurality of accounts may be randomly generated or created in strings (e.g., NAME1000@serviceprovider.com, NAME1001@serviceprovider.com, and so on). Additionally, bad actors may be more prone to be from particular geographical regions or countries where enforcing legal action against the bad actor is more difficult or the bad actor may have an easier time hiding their identity or avoiding law enforcement. In various embodiments, geographical region can be inferred based on an IP network address—and if a VPN or other technique is used to obscure the user's original IP address, it can be inferred the user does not want her true location known (although this is not necessarily always the case). Thus, such factors of account creation data 1002 linked to those countries may indicate a higher level of fraud. This assessment may be done in real-time or near real-time during or after the account creation.

In the event that account creation data 1002 generates a risk score that exceeds a threshold 1004, such as by scoring at or higher than a particular score for risk assessment, environment 200 may proceed to tier 2 escalation factors, which correspond to account monitoring data 1008 that is detected for a time period 1009 that an account is monitored for to detect risky or fraudulent usage. In some embodiments, account monitoring data 1008 may correspond to those activities engaged in using the account, such as transaction data having amounts, number of transactions, and/or other users/accounts as senders or recipients associated with the transaction. Imposed limitations may also include those on transactions, for example, by limiting a number or amount of transactions that may be processed using the account. If the account attempts to exceed such limitations, a bad actor may be using the account for fraud. Additionally, other entity interactions and funds usage may indicate if the account is engaging in some bad behavior, such as laundering money or trolling users.

Account monitoring data 1008 may also include an email or phone number age, such as an amount of time that the contact identifier has existed. For example, long active accounts and contact identifiers may indicate that the identifier was not created just for the account and therefore has been used by a legitimate actor. Similar, an address usage, location or age may also indicate fraud or may be valid based on other online or offline presence of the address and/or usage with other services. Thus, an online presence of the user or linked to data provided by the user (e.g., email, phone number, social networking handle or account, etc.) may also be determined and used to detect fraud or validate an identity of the user (thereby reducing risk of fraud). Additionally, during the use of the account, other account action may be monitored to detect if the account is engaging in bad behavior. Account monitoring data 1008 is monitored for a time period 1009 to ensure compliance with the imposed limitations, as well as detect any fraudulent actions that may be hidden by performing other valid acts with the account.

Where scoring of the account monitoring data 1008 exceeds a threshold 1010 when processed, environment 200 may escalate to tier 1, where tier 1 escalation factors 1012 may be processed to determine if further identity confirmation may be required and/or further limitations may be applied to the account. For example, without providing identity confirmation, the user may only be capable of certain transactions or may not engage in services through the account. At tier 1, an account verification challenge 1014 may be issued to the user of the account, which may include KYC data requests and/or PII that may be required from the user, which corresponds to data that may confirm an identity of a user and thereby reduce risk of fraud by the account. The challenge may be sent to the account and/or accessible through the account, for example, through one or more user interfaces of a portal for the account. Additionally, account verification challenge 1014 or an alert may be sent to the contact identifier for the account so that the challenge may be accessed. If the response to account verification challenge is insufficient or further indicates fraud, environment 200 escalates to tier 0, when an in-person identity verification 1020 may be required. Without such a verification, the account may be restricted, banned, and/or deleted.

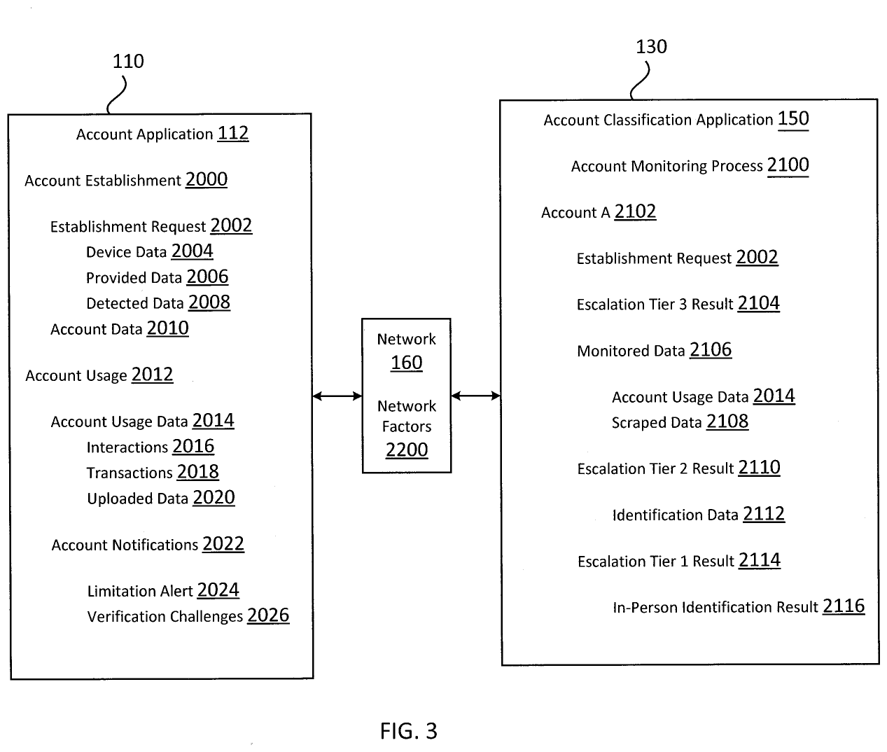

FIG. 3 is an exemplary system environment where a user device and an account service provider server may interact to detect accounts created with the intent to commit fraudulent acts, according to an embodiment. FIG. 3 includes user device 110 and service provider server 130 discussed in reference to system 100 of FIG. 1.

In environment 300, user device 110 executes account application 112 corresponding generally to the processes and features discussed in reference to system 100 of FIG. 1. In this regard, account application 112 may be used to request generation of an account, as well as use and/or maintain the account. Account application 112 may therefore be used by a legitimate user to engage in use of the service provider services, but may also be used by bad actors to engage in fraud or malicious activities. Thus, service provider server 130 may restrict usage of an account through account application 112 and may further request data and score the data to determine whether to escalate the account's risk assessment and restrictions. Thus, account application 112 may include account establishment 2000, such as a request or operation to establish the account, may perform account usage 2012, and may receive account notifications 2022. Account establishment 2000 includes data generated or provided at account setup or creation, including an establishment request 2002 having device data 2004, provided data 2006, such as user input, and detected data 2008, such as network factors, geo-location, IP address, and the like. This data may be processed to determine whether service provider server 130 may escalate an account risk assessment and further monitor the account for potential of being used fraudulently.

After account creation, account application 112 may generate data for account usage 2012 based on the interactions and operations performed using the account. Account usage 2012 may include account usage data 2014 having interactions 2016, transactions 2018, and/or uploaded data 2020. This data may be processed by service provider server 130 to further determine whether account notifications 2022 need to be issued to the account holder, such as a limitation alert 2024 of a limitation imposed on the account and/or verification challenges 2026 that may request identity confirmation from the user to reduce risk of fraud. Thus, in environment 300, service provider server 130 executes account classification application 150 corresponding generally to the processes and features discussed in reference to system 100 of FIG. 1, such as scoring engine 152 for accounts 142. In this regard, account classification application 150 may score accounts at creation, when monitoring account activities, and based on challenges for a user's identity verification.

For example, account monitoring process 2100 may be used on data from account application 112 and/or other data that may be detected or scraped for a user, device, and/or account. In this regard, account monitoring process 2100 may be used on account A 2102, such as by processing establishment request 2002 data that is detected at a time of account creation to determine whether escalation from an initial tier may occur. Establishment request 2002 may also be received over network 160 and therefore generate network data 2200 that may also be processed when determining if an account creation indicates fraud. In response to scoring the data for establishment request 2002, an escalation tier 3 result 2104 may be determined, whereby an account may be escalated to another tier if the score exceeds a threshold. Moreover, escalation tier 3 results 2104 may include imposing one or more restrictions or limitations on the account. In response to escalating the account to another tier, monitored data 2106 may be processed for the account of the account's data during a monitoring time period, such as account usage data 2014 as well as scraped data 2108 from one or more online resources or other available data. Escalation tier 2 result 2110 may be determined based on monitored data 2106, which may correspond to further escalating the account's risk assessment if monitored data 2106 indicates fraud. In response to escalation tier 2 result 2110, identification data 2112 may be requested from account application 112, such as one or more of verification challenges 2026. In response to the identification data 2112, if the identity of the user cannot be validated, an escalation tier 1 result may further escalate the risk assessment score, which may then proceed to an in-person identification result 2116 based on requiring in-person identification.

An account may have particular restrictions placed on it depending on what account classification tier it is placed in following account creation. An account that exhibits only some characteristics of a bad actor, for example, could be limited to only a certain number of transactions, or a low dollar amount (e.g. $100, $250) on total transactions before a higher level of verification is required. Such restrictions are discussed further below and herein.

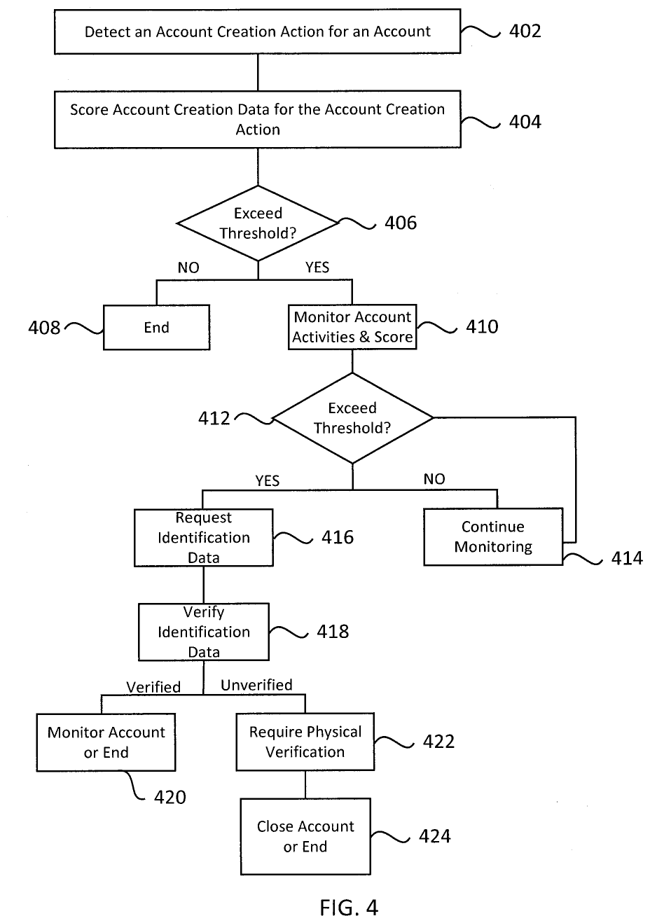

FIG. 4 is a flowchart 400 for tracking of device identification data and account activities for identification of fraudulent accounts, according to an embodiment. Note that one or more steps, processes, and methods described herein may be omitted, performed in a different sequence, or combined as desired or appropriate.

At step 402 of flowchart 400, an account creation action for an account is detected, such as by a user device accessing a portion, operation, or interface associated with account setup and creation of a new user account or by the user device sending an account creation request. Since accounts may be used by both fraudulent users and legitimate users, a service provider may wish to determine whether the account is being created with the intent of violating security protocols, committing fraud, and/or engaging in other bad acts. Thus, when a user utilizes an account creation protocol or other account establishment tool, portal, and/or interface, the service provider may receive specific data for the user and/or the user's device used to establish an account for the user. This may include input of data by the user, such as a name, address, phone number, financial instrument (e.g., a debit/credit card number, bank account, etc.), or other information associated with or identifying the user. The service provider may also detect other data for the user and/or user's device, including an IP address, device identifier, and/or other data associated with the creation of an account via a device. The service provider may also determine whether the account creation request was performed or submitted through a VPN, proxy network, or using a virtual device. Thus, the account creation process or request may be accompanied with data that may be processed to determine if the user requesting the account is a bad actor and may engage in fraud or malicious conduct through the account.

The service provider may therefore determine data associated with the account creation action, including network data, device data, user input, and/or metadata associated with any of the account creation. Using this data, at step 404, account creation data for the account creation action is scored by an intelligent scoring engine based on factors, weights, and other scoring information for the particular account creation data. Scoring of the data may include determining whether the data received through the account creation or establishment process indicates that the user may be a bad actor and/or attempting to engage in fraud or other malicious acts through the account, including trolling users, engaging in criminal acts such as money laundering, attempting phishing or spam schemes, and the like. For example, user personal and/or financial data may be used to perform lookups or links to “good” actors or accounts and “bad” actors or accounts, such as those other users and/or accounts determined to be valid or those that have previously been used to perform bad actions. The data may also be compared to known locations of bad actors, such as specific countries that bad actors often originate from due to lack or reduced emphasis or sophistication of enforcement issues or legal concerns. The service provider may also score or rate the data depending on specific actions taken during the account creation process, including use of a VoIP phone number that may be easy to obtain by bad actors, use of a VPN or virtual device to mask the user's device location, or other actions that may attempt to obscure a user's identity so that the user may not be traced if the user engages in bad actions.

Thus, an account verification, classification, or validity score or rating may be determined for account creation of an account for the user, which corresponds to an evaluation of the risk that the account may be used to engage in fraud or other bad actions. At step 406, this score is compared to a threshold score, level, or other rating that would require escalation of account monitoring based on fraud potential. The threshold score may correspond to a number, score, rating, percentage, or other quantitative score associated with the potential that an account may be used to perform bad acts by a user. For example, the threshold score may be determined based on a number or percentage of other accounts having the same or similar score being detected as engaging in bad acts during past activities using the account and/or with the service provider. In this regard, if 100,000 accounts or 75% of accounts having the same or similar scores engage in bad acts, then this particular threshold score may be used to compare to the account creation score or rating determined at step 404. However, these numbers and/or percentages may vary based on one or more risk rules of the service provider. In some embodiments, the thresholds may vary based on specific data associated with the account creation. For example, a request from a location known to originate or be engaged in fraudulent activities may have a lower threshold than another location, even when all other data is the same or has equivalent risk indicators. Other examples of data than may trigger a lower threshold may include a suspect IP address, device ID, email address, or phone number, such that data of such types having a higher degree of risk may require a lower threshold than the same data with a lower degree of risk. Once a threshold is determined for an account creation request, if the score does not exceed the threshold, the account may be considered as safe or non-fraudulent, and therefore flowchart 400 proceeds to step 408 where the process ends. Additionally, at this step, the account may be created and may be trusted as the account creation data does not exceed the threshold indicating potential for fraud or other bad acts.

However, if the score exceeds this threshold, flowchart 400 proceeds to step 410, where account activities are monitored and scored. Prior to step 410, this may also include generating the account based on the account creation request. However, the account may be generated so that the account is flagged for monitoring and/or one or more limitations or restrictions may be imposed on the account based on the account creation score or rating exceeding the threshold (thereby indicating potential for fraud or bad acts by the account). Once the account is established and provided to the user, the user may access the account and utilize the account to engage in one or more services offered by the service provider. Thus, the account may engage in account activities, including messaging, social network posting, electronic transaction processing, or other action. The account activities may be monitored over a time period, such as the number, type, or substance of the account activities per day, month, etc. Moreover, the account activities may include interactions with other users, where the other user's data, risk, analysis, or activities may also be monitored to determine whether those interactions indicate fraud or other bad actions. If any limitations have been imposed on the account, the account activities may be monitored to prevent (or detect if) the user from using the account in a way that violates the limitations, such as exceeding a number or amount for allowed electronic transaction processing. Additionally, other data that may require additional analytics may be processed. For example, the user's continuous activities may also be analyzed or monitored for use, such as an online presence of the user, the user's personal data (e.g., email address, phone number, social networking account, etc.), or other user online interactions. In this regard, bad actors may be less inclined to utilize their online presence so as to avoid the risk of detection. Thus, there may be little or no actual activities tied to a particular identifier of a bad user, such as an email address or VoIP number. The account activities are scored based on one or more weights or factors that indicate whether these account activities may be fraudulent. The score of the account activities is again compared to a threshold, at step 412, in a similar manner to correlating previous bad accounts to bad users that have been detected. If the score does not exceed the threshold, then the account may continue to be monitored, at step 414, and further account activities may be again scored and compared to the threshold. Moreover, if the account continues to act in a valid manner, the service provider may determine to end the account monitoring after a time period, for example, if the account is behaving in a valid manner for multiple months, thereby indicating a validly generated account. In some examples, the threshold may be raised in time, such that as the account activities continue to show valid actions, the threshold may be raised in a next or subsequent monitoring period. Conversely, if the activities start to show signs of fraud, the threshold may be reduced for a later monitoring period.

If the score does exceed the threshold, then at step 416, identification data may be requested from the user in order to verify the identity of the user such that the risk of fraud or bad acts performed using the account is reduced (e.g., as the user may be identified and actions may be taken to remove or reverse the fraud or bad acts). For example, an account verification request may be sent to the user, account, and/or user's device so that the user is required to provide or submit particular identification data used to validate the user's account, authenticate or verify the user's identity, or otherwise trust the user, including providing financial data or legal data that may be used to penalize the user if the user acts badly. The identification data may correspond to a document or data that may confirm the user's identity, including KYC, CIP, and/or PII data. For example, a driver's license, bill with a current address, or passport may be scanned, imaged, and submitted to the service provider. The user may also be required to complete a form or fill in interface fields with personal and/or financial data that can be used to verify the user's identity and trust the user. Based on a response to the verification request of the user's identity, at step 418, the identification data is verified, which if verified may advance flowchart 400 to step 420 where the account is continued to be monitored or flowchart 400 may end.

However, if the identification data cannot be verified and/or the user does not respond to the account verification request (e.g., a lack thereof of any response to the request within a certain time period), flowchart 400 may proceed to step 422, where physical verification may be required from the user, for example, by having the user visit a specific location that has a trusted entity to verify the user's identity, or by sending the trusted entity to the user for verification. Another request, notification, or alert may be transmitted to the user, account, and/or user's device that notifies the user that the user must perform in-person verification, and a process with which to perform the in-person verification. The process may include visiting a location of the service provider, a trusted merchant or partner of the service provider, a government building or location to validate a user identity, or another trust entity that may provide in-person user verification and identification. That trusted user may then provide identity verification to the service provider. Based on the physical verification, at step 424, either the account may be closed or flowchart 400 may end (e.g., by verifying the user's identity). For example, if the user provides a passport or other identity verification at a trusted location, the account flags and/or limitations may be removed or lessened. However, if the user does not provide identification, or has not yet visited the location, the account may be closed, suspended, or otherwise limited to prevent fraud or bad acts.

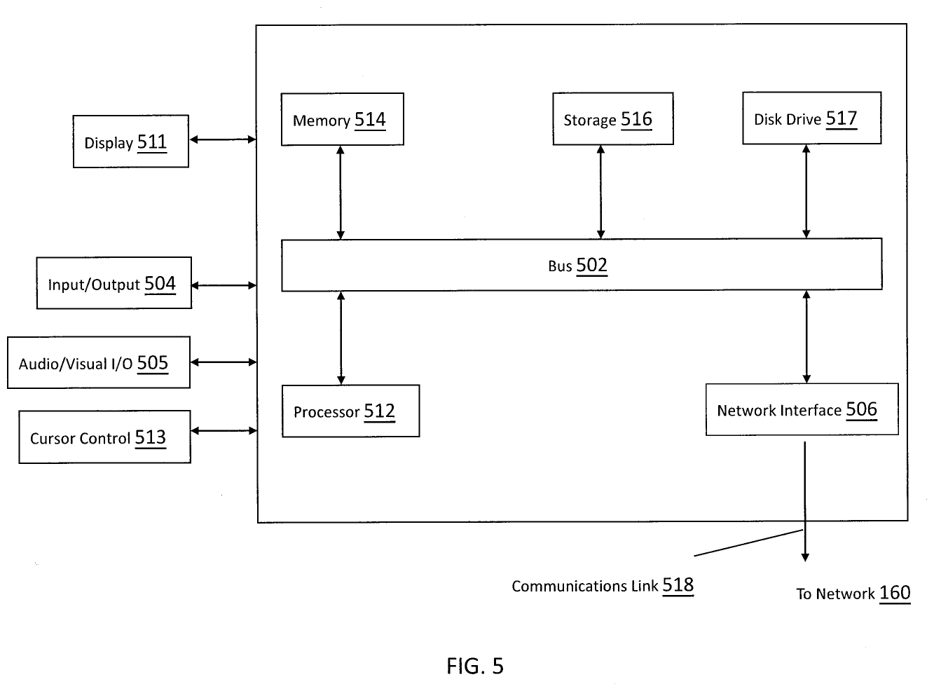

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
receiving, for an account of a user, first account data based on an account creation of the account, wherein the first account data includes at least one piece of identification data used to create the account by a first user device of the user;
generating a first account verifiability score based on a component score of each of a plurality of data items in the first account data;
responsive to a determination that the first account verifiability score exceeds a first-tier threshold for valid account creation, monitoring second account data for the account over a time period, wherein the second account data comprises at least one account activity engaged in by the account during the time period;
responsive to a determination that a second account verifiability score based on the second account data exceeds a second-tier threshold for a valid account threshold, causing an account verification challenge to be sent to the user; and
based on a response or a lack of the response to the account verification challenge, determining whether to impose a first account limitation on the account.

2. The system of claim 1, wherein the operations further comprise:
responsive to a determination to impose the first account limitation, restricting at least one account feature of the account based the first account limitation; and
requesting a physical identification document of the user to remove the first account limitation on the at least one account feature.

3. The system of claim 1, wherein the operations further comprise:
implementing, based on the determination that the first account verifiability score exceeds the first-tier threshold, a second account limitation on at least one account feature of the account prior to the monitoring the second account data.

4. The system of claim 3, wherein the at least one account feature comprises at least one of a transaction amount, a number of transactions, a transaction recipient location, a transaction recipient type, or a transaction recipient account.

5. The system of claim 1, wherein the determination that the first account verifiability score exceeds the first-tier threshold comprises:
scoring the first account data; and
determining that the scored first account data exceeds the first-tier threshold, and
wherein the determination that the second account verifiability score based on the second account data exceeds the second-tier threshold comprises:
scoring the second account data; and
determining that the scored second account data exceeds the second-tier threshold, and wherein the second-tier threshold is dynamic based on the scored first account data.

6. The system of claim 1, wherein the determination that the first account verifiability score exceeds the first-tier threshold occurs at the account creation, and wherein the determination that the second account verifiability score based on the second account data exceeds the second-tier threshold occurs during an account review process of the account after the time period based on the first account data exceeding the first-tier threshold.

7. The system of claim 1, wherein the first account data comprises at least a first indication that the account creation occurred using a virtual machine or through a virtual private network, and wherein a component score of the first indication is higher than a component score of a second indication that the account creation occurred without using the virtual machine or through the virtual private network.

8. The system of claim 7, wherein prior to the monitoring the second account data, the operations further comprise:
requesting that the user perform the account creation or verify the account without using the virtual machine or going through the virtual private network.

9. The system of claim 1, wherein the first account data comprises an email address, and wherein the email address is provided by a service provider that does not require user data for an establishment of the email address.

10. The system of claim 9, wherein prior to the monitoring the second account data, the operations further comprise:
requesting one of a different email address for the account creation or the user data for the account creation.

11. The system of claim 1, wherein the first account data comprises at least a phone number of the user, and wherein one of the plurality of data items comprises a determination the phone number comprises a voice over IP (VoIP) phone number provided by an online service provider that does not require user data for obtaining the VoIP phone number.

12. The system of claim 11, wherein prior to the monitoring the second account data, the operations further comprise:
requesting a different phone number for the user, wherein the different phone number is associated with a subscription-based service for obtaining the different phone number.

13. The system of claim 1, wherein the second account data comprises at least an account history of user activity using the account of the first account data, and wherein the account history comprises at least one interaction with a different service provider or a different user using the account.

14. A method comprising:
receiving an account creation request for an account from a computing device of a user;
determining an account creation validity score for the account creation request based on at least one piece of identification data for the computing device used during the account creation request, wherein the account creation validity score comprises a component score for each of the at least one piece of identification data;
responsive to the account creation request, generating the account based on the account creation validity score;
responsive to the generating the account based on the account creation validity score, monitoring account activity data performed by the account over a time period;
responsive to a determination that an account usage validity score based on the account activity data exceeds a first threshold score for a valid account usage, transmitting an account verification request to the user; and
based on a response or a lack of a response to the account verification request, determining whether to restrict a usage of the account.

15. The method of claim 14, wherein the generating the account further comprises imposing an account limitation on the account based on the account creation validity score exceeding a second threshold score for a valid account creation.

16. The method of claim 14, wherein prior to transmitting the account verification request, the method further comprises:
responsive to the determination that the account usage validity score based on the account activity data exceeds the first threshold score for the valid account usage, imposing a limitation on a use of the account.

17. The method of claim 16, wherein the usage of the account that is restricted comprises one of an access to the account, a transaction processing operation using the account, or an interaction with at least one other account using the account.

18. A non-transitory machine-readable medium having stored thereon machine-readable instructions executable to cause a machine to perform operations comprising:
determining identification data for a device of a user during an account setup operation performed by the device for an account with a service provider, wherein the identification data comprises at least one of a communication address or a communication network used by the device during the account setup operation;
determining a validity rating of the identification data based on a component ranking for each of the at least one of the communication address or the communication network;
responsive to a determination that the validity rating exceeds an account creation validity limit for a valid account creation of the account, monitoring account actions taken by the account during a time frame;
responsive to a determination that an account action validity rating based on the account actions exceeds an account action validity limit for valid account actions, querying the user for user verification data through the account, wherein the user verification data verifies an identity of the user; and
based on a response or a lack of the response to the querying, determining whether to limit future account actions taken by the account.

19. The non-transitory machine-readable medium of claim 18, wherein the communication address comprises at least one of a telephone number or an email address, and wherein the operations further comprise:
determining a different service provider has provided the at least one of the telephone number or the email address to the user without requiring user information for the user,
wherein the determination that the validity rating exceeds the account creating validity limit is based further on the determining that a different service provider has provided the at least one of the telephone number or the email address.

20. The non-transitory machine-readable medium of claim 18, wherein the communication network comprises a virtual private network used during the account setup operation, and wherein the operations further comprise:
determining that a network address of the device cannot be confirmed based on the device using the virtual private network,
wherein the determination that the validity rating exceeds the account creating validity limit is based further on the determining that the network address of the device cannot be confirmed.
